(19) United States
(12) Patent Application Publication
(10) Pub. No.: US 2005/0140643 A1
(43) Pub. Date: Jun. 30, 2005

(54) Pointing device

(76) Inventor: Terje Skaug, Skien (NO)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/501,676

(22) PCT Filed: Jan. 16, 2003
(86) PCT No.: PCT/NO03/00013

Related U.S. Application Data
(60) Provisional application No. 60/378,366, filed on May 8, 2002.

(30) Foreign Application Priority Data
Jan. 17, 2002 (NO) 20020268

(51) Int. Cl. G09G 5/00

(52) U.S. Cl. 345/156

(57) ABSTRACT

A device for permitting the use of an electronic device, communication device or other device as a pointing device. The device is characterised in that at least one or more pointing device components such as, for example, a mechanical or optical reader, button elements, a scroll wheel or IR port are integrated in the known electronic device or communication device, such as, for example, a mobile telephone, PDA or battery pack for a mobile telephone. The pointing device components may be provided in a new unit, which can be installed in the known electronic unit or the communication device. The device then assumes the characteristics of a pointing device, where the pointing device is capable of communicating with screen units such as, for example, a computer, a game console, PDA, mp3 player, etc.

The invention relates to a known device, which is modified to enable it to act as a pointing device or so-called mouse for use in connection with electronic or computer technological equipment. In the following, the term pointing device will be used, and this term also covers the term “mouse”.

In today's society there is an ever-increasing need for availability and flexibility both at work and during leisure time, as well as in the interface between work and leisure. The result of this is that many people find it necessary to carry one or more different units with mobile office functions, such as a mobile telephone, portable computer often with an external pointing device, game consoles, Personal Data assistance, PDA (small personal assistants). It can be a strain on the user to constantly have to transport a large number of electronic units. For reasons of convenience, therefore, it will be desirable to reduce the number of electronic aids to a minimum.

It is an object of the present invention to be instrumental in simplifying the transport situation for the users of these electronic aids. The present invention therefore attempts to provide an electronic unit where, in addition to the electronic unit's main function, a function is incorporated or can be added that helps to reduce the number of units in the mobile office.

In producing the invention the focus has been on providing a device that undertakes the function of an external pointing device, which communicates with an electronic screen unit. It is appropriate to carry an external pointing device as extra equipment when the electronic screen unit does not have an integrated pointing device or the screen unit's integrated pointing device does not work satisfactorily. The pointing device can communicate with an electronic screen unit by infrared transmission, by means of Bluetooth, via cable or other known technology. In this patent application the term electronic screen unit includes a computer, mobile telephone, PDA, etc.

A further object of the invention has been to provide an electronic aid or communication device, which can act according to its original intention, but which also has a secondary function as a pointing device.

The basis of the invention is a known electronic aid or communication device, which forms a necessary part of the mobile office, and which is therefore a unit the user will have with him/her in any case. In a preferred embodiment of the invention this original unit, which is to be modified to form a multifunctional unit, may be a mobile telephone or components that form a natural part of the mobile telephone. Furthermore, in additional embodiments of the invention, a PDA, mp3-player or a minidisk player may be used as the basis for the production of a multifunctional unit with pointing device function.

According to its object, the invention comprises the integration of components that are necessary for the known per se electronic aid or communication device to act as a pointing device. These components may, for example, be an optical or mechanical reader, various button elements, which, for example, when pushed initiate a choice as menus, acknowledgment function, pointing function, drag function, scroll wheel, etc. All components that are known from different types of mouse units will be capable of adaptation in the known electronic aid or the communication device according to the invention.

The different components mentioned above can be integrated in various ways in the known electronic unit or the communication device according to the invention. For example, the arrangement may be mentioned of pointing device components in the mobile telephone body or in the mobile telephone's battery pack so that the total arrangement is in the form of a mouse unit. The pointing device components will be arranged in the mobile telephone body in such a manner that the mobile telephone body will appear to the user like the body of the mouse. In this context the body of the mouse refers to those external surfaces of the mouse on which the user normally places his palm for navigation purposes. It is also within the scope of this embodiment for the pointing device components to be placed in the battery pack.

In a second embodiment of the invention the battery pack can be released from the mobile telephone body and act as a mouse unit that communicates with a screen unit. In this embodiment the pointing device components will be provided in the battery pack. The screen unit may be the mobile telephone associated with the battery pack, or another known screen unit. It is necessary to maintain the mobile telephone's power supply at least at a minimum when the battery pack is removed from the mobile telephone body. In this embodiment of the invention the mobile telephone may be equipped with an extra battery pack, which remains in the mobile telephone body when the battery pack that acts as the pointing device is removed from the mobile telephone.

In further embodiments of the invention the pointing device components may, for example, be arranged in a PDA, thus enabling this device to act as a pointing device in the same way as described for the mobile telephone.

Within the scope of the invention as set forth in the independent patent claim 1, it will be possible to install the components with mouse function in all types of electronic units or communication units, whose design is suitable for contact with the user's palm.

In yet another embodiment of the invention a releasable device comprising components with functions that form a necessary part of a mouse unit, i.e. the pointing device components, may be installed in to a known electronic device or communication device. As in the case of the other embodiments of the invention, with this arrangement the design of the electronic aid or the communication unit that permits it to be fitted in the user's hand is utilised in combination with the functional characteristics contributed by the components in such a manner that the total arrangement is in the form of a user-friendly pointing device.

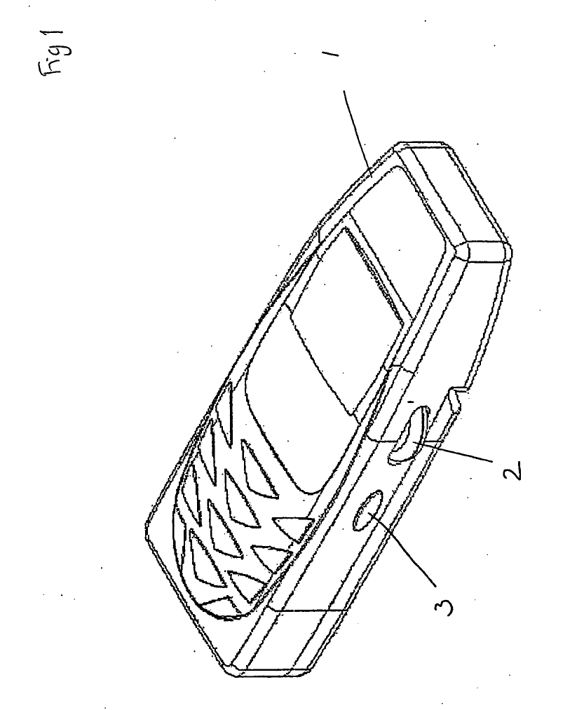

The invention will now be explained with reference to FIGS. 1-6. In these figures the invention is illustrated as a mobile telephone equipped with components with a mouse function according to two alternative embodiments of the invention.

FIG. 1 is a perspective view of an embodiment of the invention, where the modified mobile telephone is seen from the front.

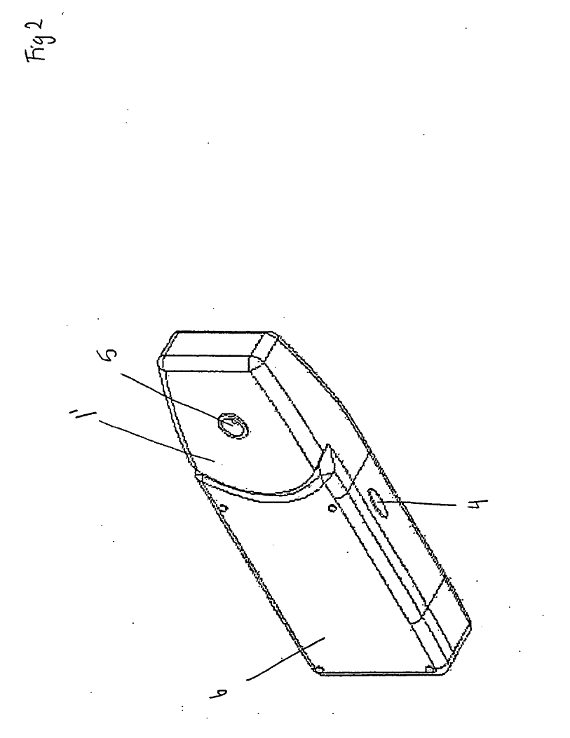

FIG. 2 is a perspective view of the modified mobile telephone in FIG. 1 seen from the rear.

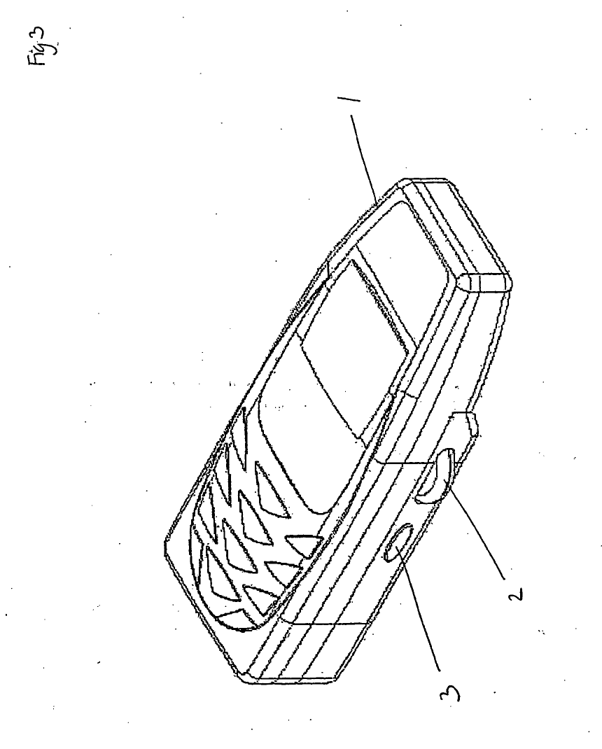

FIG. 3 is a perspective view of an alternative embodiment of the invention seen from the front of the mobile telephone.

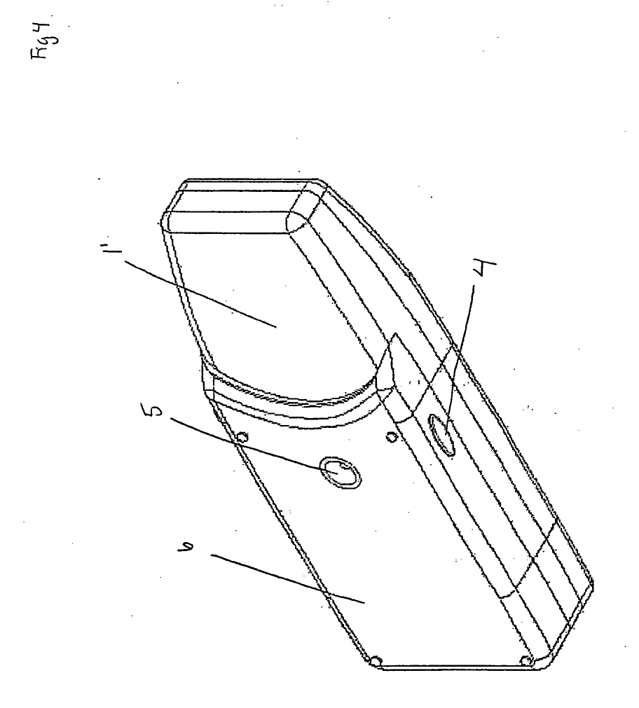

FIG. 4 illustrates the same situation as in FIG. 3, but here the mobile telephone is viewed from the rear.

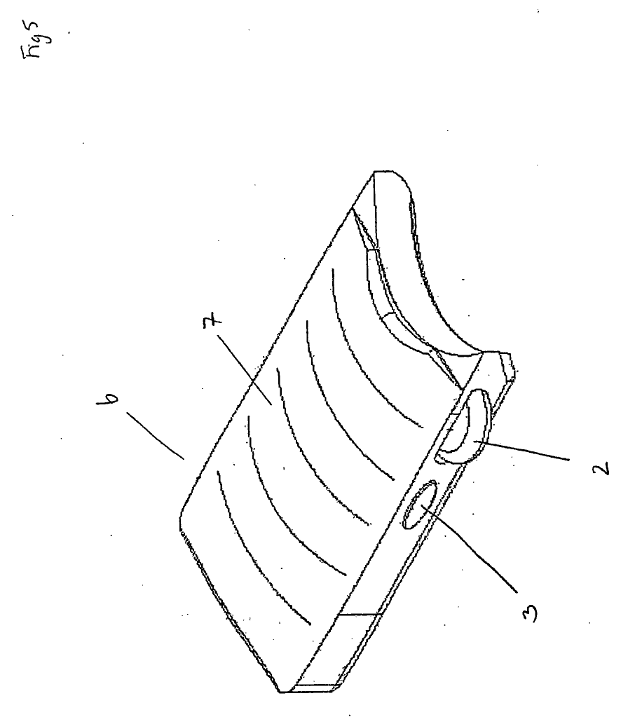

FIG. 5 is a perspective view of the battery pack removed from the mobile telephone body with the battery pack seen from above.

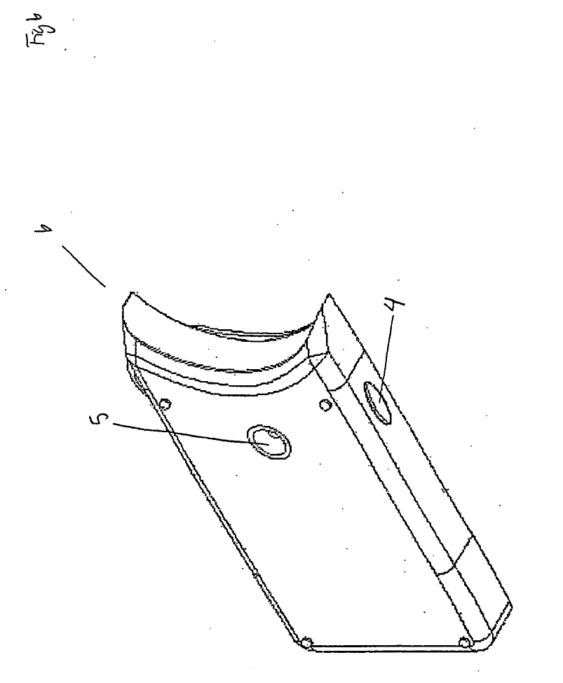

FIG. 6 illustrates the same situation as in FIG. 5, but here the battery pack is viewed from the rear.

FIG. 1 illustrates an electronic aid or communication unit in the form of a mobile telephone. In the mobile telephone 1, there are incorporated components such as a scroll wheel/button 2 and an infrared port 3.

FIG. 2 illustrates the mobile telephone body 1 viewed from the rear where a battery 6 is connected to the back 1′ of the mobile telephone in the normal known manner. Furthermore, a button element 4, for example with a “right click function” and an optical reader 5 are arranged at the back 1′ of the mobile telephone body.

By installing the illustrated components 2-5 in the mobile telephone body, the mobile telephone as illustrated in FIGS. 1 and 2 can act as a mouse unit that communicates with an electronic screen unit.

FIG. 3 illustrates the components scroll wheel 2 and IR port 3 integrated in the mobile telephone's battery pack 6, which is installed in the mobile telephone body 1.

FIG. 4 illustrates the battery pack 6 arranged on the back 1′ of the mobile telephone body. The figure also shows that the battery pack 6 is equipped with an optical reader 5 and a button element 4.

FIG. 5 illustrates the battery pack removed from the mobile telephone body 1. The battery pack 6 with the components 2-5 acts here as a mouse unit separate from the mobile telephone body 1. During use the battery pack or the mouse unit's surface 7 will be in abutment against the user's palm. When the battery pack 6 is installed in the mobile telephone body 1, the surface 7 of the battery pack will abut against the mobile telephone body 1.

FIG. 6 illustrates the battery pack illustrated in FIG. 5 from the rear. The optical reader 5 is visible here and the button 4 is also shown.

Many modifications will be possible within the scope of the invention as it is set forth in the independent patent claim. The pointing device components may, for example, be arranged on a plate that is fixed to the mobile telephone body or may be integrated in an extra module that is attached to the card end of the mobile telephone.

1. A device for giving an already existing electronic device an auxiliary function as a pointing device, characterized in that at least one or more pointing components are integrated in the electronic device, thus enabling it to act together with an external electronic screen device, which makes use of the pointing device.

2. A device according to claim 1, characterized in that the electronic device's already existing optical or radio transmission means are utilized for wireless connection to the electronic screen device.

3. A device according to claim 1, characterized in that the pointing device components comprise at least one of the following components: a mechanical or optical reader, a button element and a scroll wheel.

4. A device according to claim 1, characterized in that the pointing device components are integrated in an auxiliary unit, which is releasably mounted to the electronic device in such a manner that the auxiliary unit can be released and act as a pointing device separately therefrom.

5. A device according to claim 4, characterized in that the auxiliary unit comprises optical or radio transmission means that permit wireless connection to an electronic screen connection.

6. A device according to claim 4, characterized in that the auxiliary unit is a battery pack.

7. A device according to claim 3, characterized in that the pointing device components are integrated in an auxiliary unit, which is releasably mounted to the electronic device in such a manner that the auxiliary unit can be released and act as a pointing device separately therefrom.

8. A device according to claim 7, characterized in that the auxiliary unit comprises optical or radio transmission means that permit wireless connection to an electronic screen connection.

9. A device according to claim 5, characterized in that the auxiliary unit is a battery pack.
